(19) United States
(12) Patent Application Publication
(10) Pub. No.: US 2018/0187715 A1
(43) Pub. Date: Jul. 5, 2018

(54) AXIAL BALL JOINT

(71) Applicant: ZF Friedrichshafen AG, Friedrichshafen (DE)

(72) Inventors: Tobias LAHRMANN, Osnabrück (DE); Arnold BLANKE, Damme (DE); Thomas HERRMANN, Belm (DE); Michael ROSSOL, Stemwede-Dielingen (DE)

(21) Appl. No.: 15/738,213

(22) PCT Filed: May 23, 2016
(86) PCT No.: PCT/EP2016/061520

§ 371 Date: Dec. 20, 2017

(30) Foreign Application Priority Data
Jun. 25, 2015 (DE) 10 2015 211 765.0

(51) Int. Cl. F16C 11/06

(52) U.S. Cl. CPC F16C 11/0642; B62D 7/163; F16C 11/0652

(57) ABSTRACT

Axial ball joint (1), particularly for use in a steering gear (7), which includes a joint housing (2) open on a first side for receiving a joint ball (4) attached to a joint stud (5). A housing stud (3) is arranged on the joint housing (2). A damping device (10) is provided on the side of the joint housing (2) on which the housing stud (3) is formed. The damping device (10) includes an elastic damping element (11) made of plastic with a metallic insert (12). The metallic insert (12) is embedded in the material of the elastic damping element (11) by injection molding.

This application is a National Stage completion of PCT/EP2016/061520 filed May 23, 2016, which claims priority from German patent application serial no. 10 2015 211 765.0 filed Jun. 25, 2015.

### FIELD OF THE INVENTION

The invention concerns an axial ball joint, particularly for use in a steering gear.

### BACKGROUND OF THE INVENTION

Such axial ball joints are generally known from the prior art and are used in particular in vehicle steering systems. Expediently, vehicle steering systems comprise end-limiting means in order to determine their maximum deflection. If the steering is brought into the area of the end-limiting means, the mechanical limiting of the steering deflection leads to a hard arrest of the steering in the end area. To protect the steering gear from mechanical damage it is known from the prior art to provide the axial ball joint associated with the tie rod with an impact damper.

In this context reference should be made to DE 10 2008 007 107 A1, which discloses an axial ball joint for a steering gear, comprising a steering housing open on one side for receiving a joint ball attached to a joint stud, wherein a housing stud is arranged on the joint housing and wherein on the side of the joint housing on which the joint stud is formed, a damping device is provided. In this case the damping device acts as an impact damper fitted on the axial pot of the axial ball joint, this being located at the interface with the steering gear between the axial ball joint and the toothed rack.

In the axial ball joint known from DE 10 2008 007 107 A1 the damping device used is in the form of an annular bead, and according to an embodiment illustrated in FIG. 2 of the document this is pressed onto a metal inlay against a step of the joint housing to make the damping device more stable.

### SUMMARY OF THE INVENTION

A purpose of the present invention is to indicate an axial ball joint of the type described to begin with, which when used as directed in a steering gear is improved in the respects that besides protecting the steering gear against mechanical damage and limiting the steering deflection as precisely as possible, great durability of the damping device is achieved. Furthermore it should be possible to produce the axial ball joint economically and to use it in vehicles of various types.

The objectives are achieved by an axial ball joint according to the characteristics specified in the claims. This is distinguished in that the damping device comprises an elastic damping element made of plastic with a metallic insert, the metallic insert having the material of the elastic damping element injection-molded around it.

In this context it was first recognized that an essential function of an axial ball joint used in a steering gear is to protect the steering gear against mechanical damage. Mechanical damage can be caused in particular in that in a workshop the steering of the jacked up vehicle is swung by the wheels against the steering end-stop. It was recognized that the forces occurring on the housing of the steering gear during this can advantageously be reduced to a non-damaging level by means of a damping device arranged on the side of the joint housing provided with the housing stud. Thanks to the association so realized and by integrating the damping device in the axial ball joint assembly, damage is avoided in a simply designed manner. At the same time the damping device is used to limit the steering deflection and to determine the maximum toothed rack stroke.

In addition, according to the invention it was recognized that the damping device used in the axial ball joint has to withstand high loads in some situations. To achieve high load-bearing ability, according to the invention the damping device is specially designed in that it comprises an elastic damping element made of plastic with a metallic insert, wherein the material of the elastic damping element is injection-molded around the metallic insert. Thus the metallic insert is embedded in the material of the elastic damping element and is therefore protected as much as possible against outside influences such as corrosion. In this context injection molding can be understood to mean complete embedding in the molded material so that the metallic insert is completely surrounded by the material of the elastic damping element. However, in the context of this invention embedding can also mean in particular a partial embedding, such that the metallic insert is indeed largely surrounded by the material of the elastic damping element but not everywhere. Here, various designs are conceivable.

According to an advantageous further development of the axial ball joint, the damping element and the metallic insert are annular and are arranged coaxially with one another. Such a design and arrangement of the damping element and the metallic insert has the advantage that the damping element can be fitted with comparatively little effort onto the housing stud of the steering housing, since it is a substantially rotationally symmetrical component which does not need to be orientated in any particular way.

The elastic damping element is basically made from a plastic suitable for the purpose, advantageously from thermoplastic polyurethane.

By virtue of the claimed manner of producing the damping device, according to which the metallic insert is embedded in the material of the elastic damping element, in a simple way it is ensured that the damping device and the metallic insert are connected to one another in a form-enclosing manner. This type of connection between the elastic damping element and the metallic insert ensures, with relatively little production effort, that the metallic insert and the elastic damping element are firmly connected to one another and that the susceptibility of the unit to mechanical stress is low.

According to an advantageous further development of the axial ball joint, in relation to a radial plane the damping device is made essentially symmetrically. By virtue of a symmetrical arrangement relative to the radial plane the damping device can absorb a relatively large proportion of the impact energy, since there is an equal amount of damping material on either side of the radially extending plane of symmetry.

To fulfill the basic function of the damping device, namely to protect from mechanical damage, the damping element advantageously has on axially opposite sides in each case an axial contact surface. In the undeformed condition, when the steering stop is reached, on one side the joint housing and on the other side the housing of the steering gear come into contact with the axial contact surfaces of the damping element. As soon as the two axial contact surfaces are in contact, respectively, with the joint housing and the steering gear, then—if any more force is applied—the damping element can deform so that the impact energy is absorbed.

In an advantageous further development of the axial ball joint, at least one opening is provided in the damping element in order to expose a functional element of the metallic insert. In this case the metallic insert is only partially surrounded by the material of the elastic damping element, namely in all areas in which no opening is provided. The functional element of the metallic insert can basically be any functional unit, and the at least one opening serves to ensure that this functional element is not covered by the material of the damping element. Various such functional elements are conceivable.

Advantageously, the at least one opening leaves free an axial stop of the metallic insert which limits the axial deformation of the damping device. Accordingly, at least one axial stop is formed on the metallic insert, which is left uncovered by virtue of the opening. Thus the axial stop is not covered by the material of the damping element, so that—in the deformed condition of the elastic damping element—it can come directly into contact with the joint housing or the steering gear housing and in that way determine exactly the end-stop position of the steering deflection. Since the end-stop is therefore reached without interposition of any plastic, the end-stop position can be defined very exactly.

Preferably, a plurality and best of all six axial stops are formed on the metallic insert, spaced uniformly apart from one another around the circumference. By virtue of the formation of several axial stops the impact forces are distributed over several areas, upon each of which therefore lower and uniform forces act. Particularly advantageously, the axial stops are formed on axially opposite sides, in particular on a side of the metallic insert facing toward the joint housing and on a side facing toward the steering gear. Such a design corresponds to the symmetry already described earlier in relation to the radial plane of the damping device.

Expediently, the axial stops formed on the metallic insert are set back relative to the axial contact surfaces of the damping element in its undeformed condition. What this achieves is that when the steering stop is reached, a defined deformation of the elastic damping element first takes place, whereby the movement energy can be absorbed almost completely. But if the movement energy exceeds the energy absorbed by the damping element, then the axial stops of the metallic insert ensure an exact end-limitation of the steering stroke.

An advantageous further development provides that the openings formed widen out so as to ensure that even if the material is displaced in the compressed condition of the damping device, the axial stops will come into direct contact with the stop surfaces on the joint housing and the steering gear.

As already mentioned, at least one opening is advantageously provided in the damping element in order to leave free a functional element of the metallic insert. In an advantageous further development of the invention, such an opening can also serve to expose an inward-facing tab formed on the metallic insert. Such a tab can serve in particular to secure the damping device relative to the toothed rack in the manner of a locking device.

Accordingly, on the metallic insert a plurality, advantageously three radially inward-facing tabs are formed on the metallic insert, each of which is farther away from the central axis of the axial ball joint than a step formed on the joint housing, but a smaller distance away than an outer circumference of the toothed rack. By virtue of these dimensions it is first ensured that there is a free space between the metallic insert and the step in the joint housing, so that an axial play is possible between them. Furthermore, in the manner of a locking device the damping device is effectively prevented from slipping in the axial direction over a toothed rack of the steering gear to be attached to the joint housing. Advantageously, the tabs are evenly spaced apart from one another around the circumference.

### BRIEF DESCRIPTION OF THE DRAWINGS

Below, the invention is explained in more detail with reference to a drawing, from which there also emerge further advantageous design features of the invention. The drawing shows:

FIG. 1: An arrangement of a tie rod and steering gear, viewed from the side,

FIG. 2: An axial ball joint in its end-stop position on the housing of the steering gear,

FIG. 3: A damping device of an axial ball joint according to the invention, shown in a perspective, partially sectioned view.

### DETAILED DESCRIPTION OF THE PREFERRED EMBODIMENTS

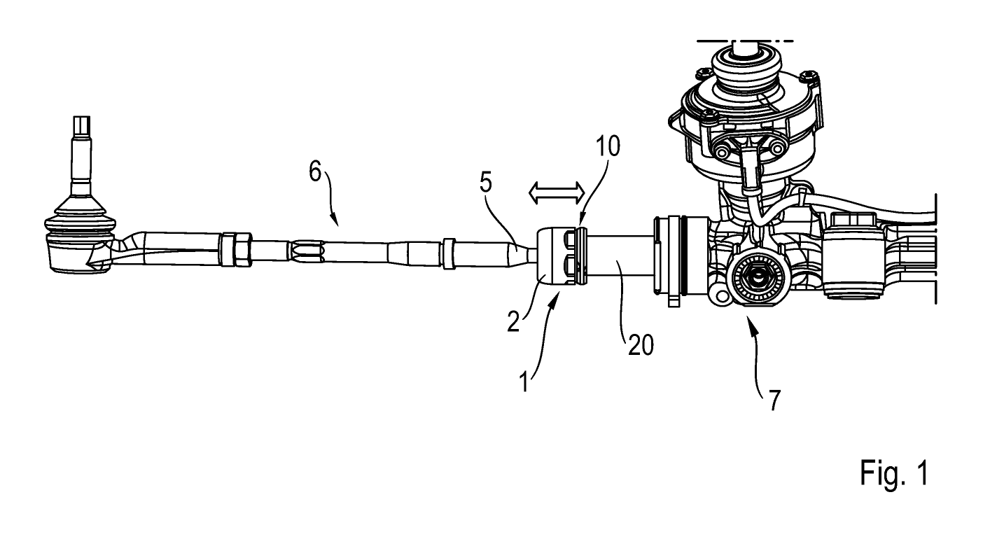

FIG. 1 shows a side view of a tie rod 6 with an axial ball joint 1 by which it is mechanically connected to a steering gear 7. Adjustment movements caused by the steering gear 7 produce a displacement of the axial ball joint 1 in the direction indicated by the double arrow. The axial ball joint 1 comprises a joint housing 2 open on one side, which receives a joint ball (not shown). The joint ball is attached to a joint stud 5, which can therefore pivot around the ball relative to the joint housing 2. On the side of the joint housing 2 facing toward the steering gear 7 is arranged a damping device 10. The damping device 10, also known as the impact damper, is mounted on the axial pot of the axial ball joint 1. In the assembled condition shown, the damping device 10 is at an interface with the steering gear 7, between the joint housing 2 and a toothed rack 20.

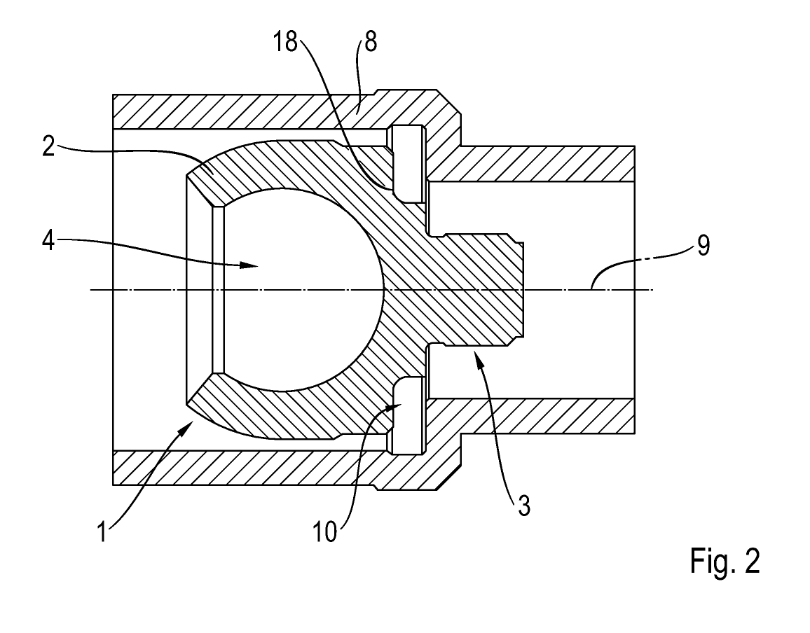

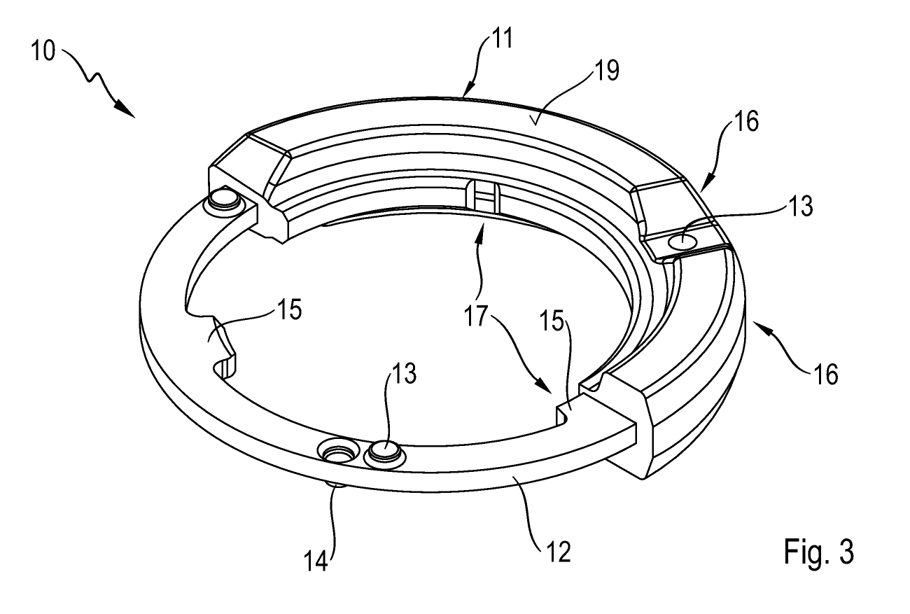

Depending on the steering angle (left and right) the toothed rack 20, including the axial ball joint 1 connected thereto, moves back and forth in the direction of the double arrow. An essential function of the damping device 10 is to protect the steering gear 7 from mechanical damage, which can take place if, when the vehicle is jacked up, the wheels swing against the steering end-stop. The forces then produced, which act upon the housing 8 of the steering gear 7, are reduced by the damping device 10 to a non-damaging level. The structure and arrangement of the damping device 10 on the axial ball joint 1 will be explained in more detail below with reference to FIGS. 2 and 3.

FIG. 2 shows a section through the joint housing 2 of the axial ball joint 1 already shown in FIG. 1, wherein for representational reasons the joint stud 5 is not shown although the position of a joint ball 4 associated with the joint stud 5 is indicated. The joint housing 2 is a component open on one side, which is suitable for receiving the joint ball 4 associated with the joint stud 5. On a side of the joint housing 2 facing away from the housing opening, a housing stud 3 is arranged which projects from the joint housing 2 in the direction along a central axis 9 of the axial ball joint 1.

On the side facing toward the housing stud 3, the joint housing 2 has a step 18. A damping device 10, to be explained in more detail below, is set into the step 18. In this case the damping device 10 is fixed onto the step 18 by a press fit. The press fit is produced by pressure between the material of a plastic ring 11 and the outer circumference of the step 18.

In the condition shown in FIG. 2 the joint housing 2 is in an end-stop position relative to the housing 8 of the steering gear 7. In other word, referring to the representation in FIG. 1 the joint housing 2 has moved far enough to the right for the damping device 10 arranged on the joint housing 2 to be in contact with the housing 8 of the steering gear 7. Owing to a force that acts along the central axis 9 in the direction toward the steering gear 7, the joint housing 2 exerts a force on the damping device 10 which results in a deformation of the damping device 10 between the joint housing 2 and the housing 8 of the steering gear 7. The structure of the damping device 10 and the way it functions are described in detail below with reference to FIG. 3.

FIG. 3 shows a perspective, partially sectioned view of a damping device 10 used in an axial ball joint 1 according to the invention as already explained with reference to FIGS. 1 and 2. The damping device 10 is an annular component that consists of an elastic damping element 11 made from polyurethane and a metallic insert 12, the metallic insert 12 being embedded in the material of the elastic damping element 12 by injection molding. In the example embodiment shown the embedding is only partial, with the metallic insert 12 very largely surrounded by the material of the elastic damping element 11.

By virtue of the embedding, the elastic damping element 11 and the metallic insert 12 are connected to one another in a form-enclosed manner. Relative to a radial plane the damping device 10 is essentially symmetrical. Relative to a central radial plane of the damping device 10 the material of the damping element 11 and the metallic insert 12 extend uniformly in both axial directions.

The metallic insert 12 is almost completely enclosed by the material of the elastic damping element 11. The embedding is only interrupted by openings 16, 17, which are provided in order to leave free functional elements 13, 14, 15 of the metallic insert 12.

On the metallic insert, referring to the representation shown in FIG. 3, on the side facing upward three axial stops 13 are formed, offset from one another around the circumference by 120°. The axial stops 13 are projections stamped into the material of the metallic insert. In the opposite direction, i.e. on the side facing downward in the drawing, there are also three axial stops 14 equally spaced around the circumference, which are offset from one another by 120° around the circumference. Correspondingly, on each side of the damping element 11 there are three, so a total of six openings, each of which leaves free a stop 13, 14 corresponding to it.

Referring to the assembled condition shown in FIG. 1, the stops 13, 14 are therefore on axially opposite sides, namely on a side facing toward the joint housing 2 and on a side facing toward the steering gear 7 of the metallic insert 12. Thus, in relation to an axial contact surface 19 of the damping element 11 in its undeformed condition the axial stops 13, 14 are in each case axially farther back. This arrangement ensures that contact between the joint housing 2 and the housing 8 of the steering gear 7 first takes place by way of the contact surface 19 of the damping element 11 and only when the elastic damping element 11 is fully compressed is an end-stop position reached by virtue of the axial stops 13, 14.

The openings 16 widen out in an approximately funnel-shape, in order to ensure that even if the material is displaced in the compressed condition of the damping device 10, the stops 13, 14 come into direct contact with contact surfaces on the joint housing 2 and the steering gear 7 respectively.

Besides the axial openings 16, in the elastic damping element 11 three more openings 17 are provided, each of which exposes a radially inward-extending tab 15 formed on the metallic insert 12. Correspondingly, on the metallic insert 12 there are formed three inward-extending tabs 15 offset from one another by 120° and thus uniformly spaced apart from one another.

The tabs 15 are each farther away from the central axis 9 of the axial ball joint 1 than a step 18 formed on the joint housing 2, but less far from it than an outer circumference of the toothed rack 20. By virtue of these dimensions, in accordance with which the three inward-directed tabs 15 have a larger inside diameter than the associated outer diameter of the joint housing 2 in the area of the step 18, it is in the first place ensured that there is a free space between the metallic insert 12 and the step 18 of the joint housing 2, which space allows some axial play between them. Furthermore, the dimensions effectively prevent the damping device 10 from sliding in the axial direction against a toothed rack 20 of the steering gear 7 to be fixed to the joint housing 2. Thus, the tabs 15 serve as locking means which secure the damping device 10 axially relative to the toothed rack 20.

### INDEXES

1 Axial ball joint
2 Joint housing
3 Housing stud
4 Joint ball
5 Joint stud
6 Tie rod
7 Steering gear
8 Housing of the steering gear
9 Central axis
10 Damper
11 Plastic ring
12 Sheet-metal ring
13 Stud
14 Stud
15 Tab
16 Opening
17 Opening
18 Step
19 Contact surface
20 Toothed rack

1-14. (canceled)

15. An axial ball joint (1) comprising:
a joint housing (2) being open on one side for receiving a joint ball (4) attached to a joint stud (5);
a housing stud (3) being arranged on the joint housing (2);
a damping device (10) being provided on a side of the joint housing (2) on which the housing stud (3) is formed; and
the damping device (10) comprising an elastic damping element (11) made of plastic with a metallic insert (12) such that the metallic insert (12) being embedded in a material of the elastic damping element (11) by injection molding.

16. The axial ball joint according to claim 15, wherein the damping element (11) and the metallic insert (12) are annular and are arranged concentrically with one another.

17. The axial ball joint according to claim 15, wherein the damping element (11) is made from thermoplastic polyurethane.

18. The axial ball joint according to claim 15, wherein the damping element (11) and the metallic insert (12) are connected to one another in a form-enclosing manner.

19. The axial ball joint according to claim 15, wherein the damping device (10), relative to a radial plane, essentially has a symmetrical design.

20. The axial ball joint according to claim 15, wherein the damping element (11) has an axial contact surface (19) on axially opposite sides thereof.

21. The axial ball joint according to claim 15, wherein at least one opening (16, 17) is formed in the damping element (11) in order to leave a functional element (13, 14, 15) of the metallic insert (12) exposed.

22. The axial ball joint according to claim 21, wherein the at least one opening (16) exposes an axial stop (13, 14) of the metallic insert (12) which limits the axial deformation of the damping device (10).

23. The axial ball joint according to claim 15, wherein a plurality of axial stops (13, 14) are formed on the metallic insert (12) and are distributed equally spaced apart from one another around a circumference of the metallic insert (12).

24. The axial ball joint according to claim 23, wherein the axial stops (13, 14) are formed on axially opposite sides of the metallic insert (12).

25. The axial ball joint according to claim 23, wherein in an undeformed condition of the damping element (11), the axial stops (13, 14), relative to axial contact surfaces (19) on axially opposite sides of the damping element (11), are set back.

26. The axial ball joint according to claim 21, wherein the openings (16) widen out in order to ensure that the axial stops (13, 14) come into direct contact with contact surfaces on the joint housing (2) and on a steering gear (7) even if material is displaced in a compressed condition of the damping device (10).

27. The axial ball joint according to claim 21, wherein the at least one opening (17) exposes a tab (15) formed on the metallic insert (12), and the tab extends radially inward.

28. The axial ball joint according to claim 15, wherein a plurality of radially inward-extending tabs (15) are formed on the metallic insert (12), each of the tabs being farther away from the central axis (9) of the axial ball joint (1) than is a step (18) formed on the joint housing (2), but less than an outer circumference of a toothed rack (20).

29. The axial ball joint according to claim 23, wherein the axial stops (13, 14) are formed on a side of the metallic insert (12) facing toward the joint housing (2) and on a side of the metallic insert (12) facing toward the steering gear (7).

30. An axial ball joint in a steering gear, and the axial ball joint comprising:
a joint housing having a first side with an opening which receives a joint ball attached to a joint stud;
a second opposite side of the joint housing having a housing stud;
a damping device being arranged on the second side of the joint housing, and the damping device comprising an annular elastic damping element made of plastic in which an annular metallic insert being embedded by injection molding;
the elastic damping element having an axially facing contact surface with axially directed openings;
the metallic insert having axially extending stops that open into the axially directed openings of the elastic damping element and being set back from the axially facing contact surface of the axially facing contact surface.
